(19) United States
(12) Patent Application Publication
(10) Pub. No.: US 2025/0019233 A1
(43) Pub. Date: Jan. 16, 2025

(54) RETROFITTING GAS TO LIQUIDS PROCESSING UTILIZING CARGEN TECHNOLOGY

(71) Applicant: Qatar Foundation for Education, Science and Community Development, Doha (QA)

(72) Inventors: Nimir O. Elbashir, Doha (QA); MohamedSufiyan A. Challiwala, Doha (QA); Hanif Ahmed Choudhury, Doha (QA); Zeinab Ataya, Doha (QA); Debalina Sengupta, Doha (QA); Mahmoud M. El-Halwagi, Doha (QA)

(21) Appl. No.: 18/708,742

(22) PCT Filed: Nov. 9, 2022
(86) PCT No.: PCT/QA2022/050022

§ 371 Date: May 9, 2024

Related U.S. Application Data
(60) Provisional application No. 63/277,890, filed on Nov. 10, 2021.

(51) Int. Cl. C01B 3/24; B01D 53/14; C01B 32/16

(52) U.S. Cl. CPC C01B 3/24; B01D 53/1475; C01B 32/16; B01D 2252/204; B01D 2257/504; C01B 2202/06; C01B 2203/0415; C01B 2203/062; C01B 2203/1241; C01B 2203/148

(57) ABSTRACT

A retrofitted gas to liquid (GTL) process implemented with CARGEN® technology is provided. The retrofitting modifications enable significant greenhouse gas (CO₂, CH₄, volatile organic compounds, and the like) conversion via CARGEN® technology to produce carbon material and syngas. The carbon material produced by the CARGEN® technology can include amorphous carbon, carbon black, carbon nanotubes, and other allotropes of carbon. The carbon material can be used in a number of different and suitable applications, including, for example, cement industry, steel industry, rubber enforced manufacturing, to fully sequester CO₂. On the other hand, the produced syngas from the retrofitted GTL plant may be used to produce, for example, ultra-clean fuels, chemicals, and other value-added processes using Fischer-Tropsch process.

### BACKGROUND

This application claims priority to and the benefit of U.S. Provisional Patent Application No. 63/277,890 filed Nov. 10, 2021, the entire contents of which are incorporated by reference herein.

The present disclosure generally relates to retrofitting a gas to liquids (GTL) process with a CARGEN®-technology. GTL processing generally relates to a combination/cluster of processes that converts natural gas and/or other gas phase hydrocarbons (HCs) into liquid synthetic fuels, such as gasoline and diesel fuel. The GTL processing generally includes three primary processes: 1) generation of synthesis gas (syngas) via natural gas reforming; 2) syngas conversion by Fischer-Tropsch (FT) synthesis into gases, condensates HCs and water; and 3) refining section including, for example, hydrocrackers, hydrotreaters, flash separators, and fractional distillation columns.

### SUMMARY

Considering the present disclosure, and without limiting the scope of the disclosure in any way, in an aspect of the present disclosure, which may be combined with any other aspect listed herein unless specified otherwise, a CARGEN®-based retrofitted GTL process system is provided. The retrofitted GTL process achieves significant reduction in net CO₂ emissions compared to the un-retrofitted and conventional GTL process.

The system comprises a CARGEN® technology modified natural gas reforming section, a Fischer Tropsch (FT) reaction section, a refining section, and a water treatment section. The CARGEN® technology modified natural gas reforming section is demonstrated herewith to retrofit an existing GTL processing plant. The retrofitted configuration comprises of modifications that fulfill the recycling of CO₂ emissions from the GTL process plant, such as that from FT tail gases, the furnaces, and the stacks that are typically present in the GTL process plant. The functionality of CARGEN® technology, as disclosed in our previous invention (US20200109050A1), enables the production of solid carbon material as well as syngas (comprising CO and H₂) that meets the typical syngas quality requirement of the GTL process plant. In an aspect of the present disclosure, which may be combined with any other aspect listed herein unless specified otherwise, the natural gas is saturated and pre-reformed before the natural gas is combined with the recycled FT tail gas and the recycled CO₂. The input gas has a CxHy: CO₂:O₂ feed ratio in a range of 1:0.01:0 to 1:1.5:1. It should be noted that the “C” content in the ratio refers to the number of moles of carbon in the various hydrocarbons in the input gas.

As disclosed in our previous invention (US20200109050A1), the CARGEN® technology modified natural gas reforming section comprises a first reactor and a second reactor to process the input GHGs. The first reactor is configured to operate adiabatically at a pressure in a range of 1 bar to 25 bar and a maximum outlet temperature in a range of 752° F. to 1202° F. The first reactor is configured to produce a solid phase product and a vapor phase product. The solid phase product comprises of carbon allotrope. The vapor phase product comprises unreacted gases, wherein the unreacted gases comprise CO₂, CH₄, CO, H₂, and H₂O. The vapor phase product of the first reactor is fed to the second reactor. The second reactor is configured to operate isothermally at a temperature in a range of 1292° F. to 2192° F. and at a pressure in a range of 1 bar to 25 bar. The second reactor is configured to convert the vapor phase product to the syngas, wherein the converted syngas has an H₂:CO ratio in a range of 0.1 to 5. The converted syngas is delivered to the FT reaction section after the CO₂ is removed by a CO₂ separation plant (e.g., amine unit), wherein at least a portion of the CO₂ is removed from the syngas by the amine unit becomes the recycled CO₂ in the input gas.

In an aspect of the present disclosure, which may be combined with any other aspect listed herein unless specified otherwise, the carbon allotrope includes one or more of carbon black, amorphous carbon, and carbon nanotubes.

In an aspect of the present disclosure, which may be combined with any other aspect listed herein unless specified otherwise, the carbon nanotubes include Multi-Walled Carbon Nanotubes (MWCNT).

In an aspect of the present disclosure, which may be combined with any other aspect listed herein unless specified otherwise, the purity of the carbon nanotubes produced in the retrofitted GTL plant with CARGEN® Technology ranges between 1% to 100%.

In an aspect of the present disclosure, which may be combined with any other aspect listed herein unless specified otherwise, the CARGEN® integrated GTL process plant and the associated process will convert at least 50% CO₂ conversion.

### BRIEF DESCRIPTION OF THE DRAWINGS

Features and advantages of the present disclosure, including retrofitting a GTL process with a CARGEN® technology described herein, may be better understood by reference to the accompanying drawings in which:

FIG. 1 is a diagram of an example CARGEN® technology two-reactor set up according to the present disclosure.

FIG. 2 is a flow diagram illustrating the operation of an example GTL process with CARGEN® technology, according to an example of the present disclosure.

FIG. 3 is a flowsheet showing the operation of an example conventional reforming process (e.g., Autothermal Reformer (ATR)-based GTL plant).

FIG. 4 is a flowsheet showing the operation of an example CARGEN® technology-based GTL plant.

FIG. 5 is a diagram showing a reforming unit of a CARGEN®-based GTL plant/system.

FIG. 6 is a diagram showing a syngas conditioning unit of the CARGEN®-based process.

FIG. 7 is a table of an ATR-based model component relative difference report generated by ASPEN Plus®.

FIG. 8 is a table of a CARGEN-based model component relative difference report generated by ASPEN Plus®.

FIG. 9 is a diagram showing ASPEN Plus® simulation of 7,000 tons/day CO₂ conversion using the CARGEN two-reactor process.

### DETAILED DESCRIPTION

CARGEN® (CARbon GENeretor) is an innovative approach for producing syngas and carbon from CO₂ and natural gas, as disclosed in our previous invention (US20200109050A1). CARGEN® process may address the challenges of Dry Reforming of Methane (DRM) by a unique reaction design that segregates the competing side reactions within DRM, which are carbon formation reactions and syngas production.

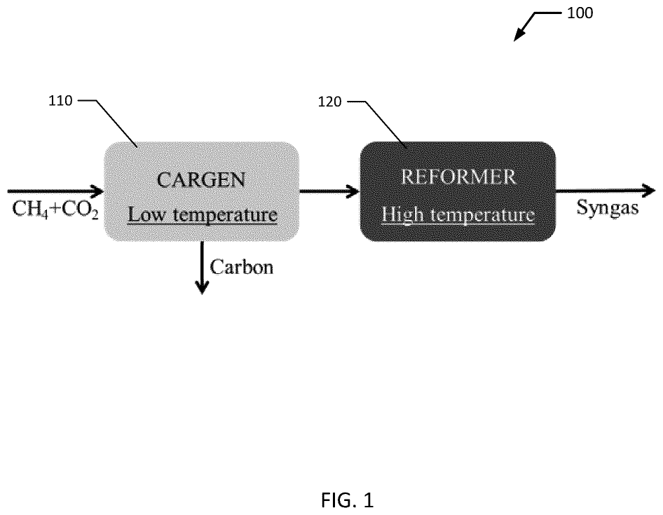

FIG. 1 is a schematic diagram of an example two-reactor CARGEN® system 100. The system 100 may include a first reactor 110 and a second reactor 120. The first reactor 110 may promote methane decomposition (Eq. 1) and Boudouard reaction (Eq. 2 below), which are highly active at low-temperature conditions (752 to 1112° F.), to selectively produce solid carbon in the first reactor 110.

$$C {H}_{4} \to C + 2 {H}_{2} \qquad Eq . 1$$

$$2 CO \to C + {CO}_{2} \qquad Eq . 2$$

Also, the reaction in the first reactor 110 may be carried out in an oxygen-limited atmosphere at low temperatures to produce solid carbon. The operating conditions of CARGEN® may maximize the CO₂ fixation in the first reactor 110, thus increasing the carbon production while the predetermined concentration of oxygen drives the reaction auto-thermally. The product gases from the first reactor 110 may be sent to the second reactor 120, which is in series to the first.

The second reactor 120 in CARGEN® may be a ti-reformer, which may use a combination of Steam Reforming of Methane (SRM), Dry Reforming of Methane (DRM), and/or Partial Oxidation (POM) to produce a flexible syngas ratio that meets downstream applications like FT and methanol synthesis. Removing carbon from the first reactor 110 may allow for the operation of the second reactor 120 at a temperature lower than conventional reforming processes (that is, around 1472° F.). Moreover, the reaction may be driven by a lower energy requirement of approximately 120 kJ, making the system more energy efficient.

From the CO₂ life cycle assessment (LCA) perspective, the first reactor 110 presents an excellent opportunity for permanent sequestration of GHGs into solid carbon, an environmentally stable material. Also, the carbon product obtained from this process may be industrially valuable as it can be used in the production of value-added chemicals and materials and in niche applications like batteries, fuel cells, supercapacitors, photovoltaics, among others in addition to bulk applications like strengthening of rubber, asphaltenes, cement, etc. Moreover, the carbon material produced from CARGEN® may be MWCNTs which may bring a significant scope of economic value-addition.

The present disclosure generally relates to retrofitting a GTL process plant and associated process with CARGEN® technology. For example, the present disclosure provides integration of an existing GTL process plant and associated GTL process with a CARGEN®-technology to recycle a significant amount of CO₂ within the GTL process in addition to extra CO₂ from an external source.

In an embodiment, a CARGEN® retrofitted GTL processing facility may include a number of different and suitable process units and sub-process units. For example, the CARGEN® retrofitted GTL processing facility can include a natural gas absorption unit, a natural gas pre-reformer, a CARGEN® reactor, a natural gas reformer, a flash tank, an FT reaction system (e.g., a packed bed, a fluidized bed, or a slurry phase reactor), a hydrocracker unit, a fractional distillation column, and a water treatment plant. The CARGEN® retrofitted GTL processing facility may provide significant improvement in terms of CO₂ footprint by sequestering GHGs into solid carbon material along with syngas. The sources of GHGs comprising of CO₂, CH₄, and other volatile HCs may include flue gases, low BTU gases, flare gases, furnace gases, among others. These gases may be used individually or in combination as mixed streams.

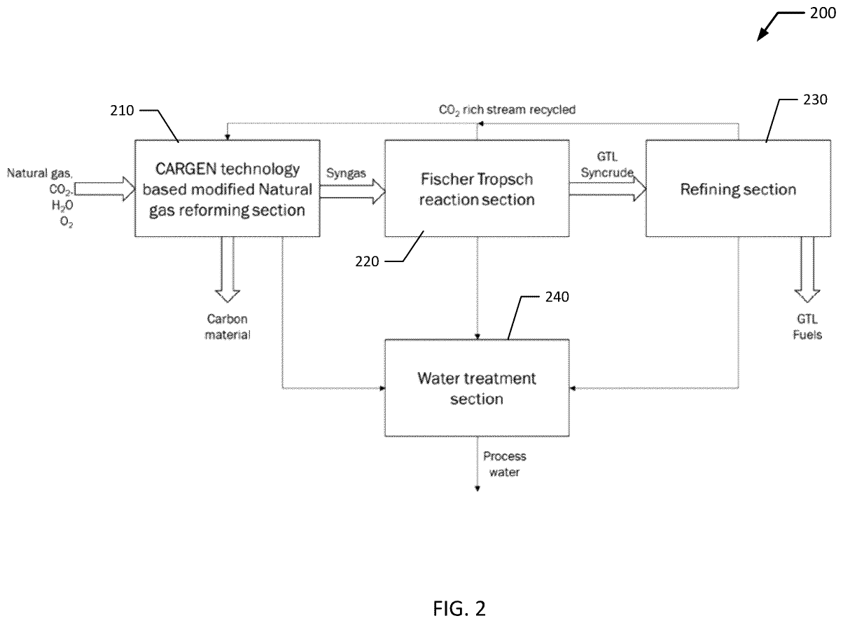

As shown in FIG. 2, a CARGEN® based retrofitted GTL process plant/system 200 according to an example of the present disclosure may include four main sections, such as, a CARGEN® technology modified natural gas reforming section 210, a FT reaction section 220, a refining section 230, and a water treatment section 240. The CARGEN® technology modified natural gas reforming section 210 may produce carbon material and syngas under suitable CARGEN® technology operating conditions. The FT reaction section 220, refining section 230, and water treatment section 240 may operate under suitable GTL plant operating conditions including, for example, some modifications pertaining to recycle of CO₂ rich streams to the CARGEN® technology-modified natural gas reforming section 210.

A gas feed stream including natural gas, oxygen, CO₂, and other suitable gas feed stream constituents, including an additional gas feed stream constituent relating to GTL processing, may be pressurized and heated at a suitable pressure and temperature and suitable ranges thereof for requisite adiabatic processing and operation conditions in the CARGEN® reactor, thereby producing desired solid and vapor phase products. For example, the natural gas, oxygen, and CO₂ streams may be compressed to the operating pressure of the CARGEN® reactor and heated to a temperature in the range of 752° F. to 1202° F. The CARGEN® reactor may be operated adiabatically at a pressure in the range of 1 bar to 25 bar and a maximum outlet temperature in the range of 752° F. to 1202° F. This reactor may produce two phases, solid and vapor.

For example, the solid phase may contain carbon nanotubes and preferably including MWCNT. In some examples, the vapor phase product may include unreacted gases (e.g., CO₂, CH₄, CO, H₂, H₂O). These unreacted gases may be in turn sent to the reformer after expansion and heating to meet the reformer requisite operating conditions.

In some examples, the reformer may be operated isothermally at a suitable temperature (e.g., in the range of 1292° F. to 2192° F., preferably 1508° F.) and pressure (e.g., in the range of 1 to 25 bar, preferably 20 bar) and suitable ranges thereof such that the unreacted gases may be converted to syngas at a suitable flexible ratio (e.g., in the range of 0.1 to 5, preferably 2.15) that meets the downstream requirements.

Examples of temperature and pressure operation conditions of the CARGEN® based reactor and the reformer according to an example of the present disclosure are as shown in Table 1 below:

TABLE 1
Operating Conditions of CARGEN ® based reactor and reformer

| | | |
|---|---|---|
| CARGEN ® reactor | Temperature | 752° F. to 1202º F. |
| | Pressure | 1 bar to 30 bar |
| Reformer | Temperature | 1292° F. to 2192º F. |
| | Pressure | 1 bar to 30 bar |

Following reforming, the obtained syngas product may undergo multiple stages of syngas conditioning before it is delivered to the FT synthesis section 220. In some examples, it may first undergo water recovery using a flash tank that may remove the liquid leaving the syngas and unreacted CO₂, which may be then provided to an amine treatment unit to remove the CO₂, thereby providing the conditioned syngas. The CO₂ may be recycled and used as a feed for the CARGEN® reactor, while the conditioned syngas may be taken to the FT reaction section 220, where they may be converted to suitable HCs (e.g., long chain HCs) during GTL processing.

The impact of the CARGEN® technology, according to the present disclosure, has been evaluated in terms of carbon footprint reduction of the GTL products. Specifically, the CARGEN®-based GTL plant reduces the CO₂ footprint to below 200 lb/bbl of GTL product compared to more than 650 lb/bbl GTL product in the conventional processes. The detailed effects of CARGEN® technology incorporation in a GTL plant have been discussed in detail below in terms of natural gas consumption, oxygen requirements, and water co-generation.
In terms of natural gas consumption, the CARGEN® retrofitted GTL plant, according to the present disclosure, in an embodiment, consume a sizeable increase in natural gas (e.g., up to about 54% increase in natural gas) as compared to the conventional reforming based GTL plant (for e.g., ATR or POX or SRM based GTL plant).
In terms of oxygen consumption, the CARGEN® integrated GTL process according to the present disclosure, in an embodiment, may reduce the oxygen consumption in a sizeable amount (e.g., up to about 94% reduction) as compared to conventional reforming process (for e.g., ATR or POX or SRM etc), which requires a high CxHy:O₂ ratio (e.g., 0.6). Therefore, implementing the CARGEN® technology according to an example of the present disclosure may greatly reduce the need for oxygen (for e.g., by almost 94% in the case of ATR or POX or SRM based GTL plant).
In terms of the water generation, an increase in the generation of water (e.g., up to about 137% increase in water generation) can be obtained in the CARGEN® integrated GTL process according to the present disclosure in an embodiment. This may be due to the shift in equilibrium in the CARGEN® reactor towards the production of water and solid carbon (e.g., MWCNT). The water can then be recycled and reused as process water, such as for irrigation after treatment.
In terms of the CO₂ emission, which can be evaluated in terms of direct and indirect CO₂ emission, the CARGEN® integrated GTL process, according to an example of the present disclosure, shows a sizeable reduction (e.g., up to about 280% reduction) in the direct CO₂ emission, where CO₂ is internally recycled and reused in the GTL integrated CARGEN® technology. Thus, the CARGEN® integrated GTL process becomes an overall net consumer in terms of direct CO₂ emission.
As for indirect CO₂ emission from energy and power production, there is an increase (e.g., up to about 160%) in the CARGEN® integrated GTL process compared to benchmark reforming processes (for e.g., Gabriel, Kerron J, et al., Industrial & Engineering Chemistry Research 53.17 (2014): 7087-7102), according to an embodiment of the present disclosure. This may be due to the added heating requirements caused by a higher natural gas demand, according to an embodiment.
However, despite the increase in indirect CO₂ emission, a sizeable reduction (e.g., up to about 75% reduction) can be achieved in terms of overall CO₂ emission in the CARGEN® integrated GTL process plant when compared to the conventional reforming process (for e.g, ATR or POX or SRM based GTL process plant) according to an embodiment of the present disclosure.

Further details relating to the various aspects of CARGEN® technology, its implementation, the catalyst, and the protocols, according to an embodiment, are disclosed in U.S. Patent Publication No. 2020/0109050 (Elbashir et al., “System and Method for Carbon and Syngas Production”), International Patent Publication No. WO2018/187213 (Elbashir et al., “System and Method for Carbon and Syngas Production”), International Patent Publication No. WO2020/185107 (Elbashir et al., “Regeneration and Activation of Catalysts for Carbon and Syngas Production”), U.S. Provisional Patent Application No. 63/188,050 (Elbashir et al., “Method to Produce Carbon Nanotubes”), and International Patent Publication No. WO2021/125990 (Elbashir et al., “Catalysts for CARGEN®, Methods of Preparing, and Uses of Same”), all of which are hereby incorporated by reference in its entirety.

In some examples, the CARGEN® technology can be operated under any suitable CARGEN® operating conditions, including within −20% to +20% range of processing and operation conditions provided in U.S. Patent Publication No. 2020/0109050 and International Patent Publication No. WO2018/187213 according to an embodiment of the present disclosure.

### Flowsheet Description

The retrofitting of the GTL process plant requires a detailed development of the existing/conventional base case process flowsheet wherein the GTL plant that is to be retrofitted is simulated using a process simulation software. Since the scope of this invention is retrofitting of a conventional GTL process plant that incorporates the benchmark reforming technology (for e.g, ATR process, POX process, SRM process etc), a detailed simulation is first conducted to simulate the overall functionality of the base case GTL plant. The simulated flowsheet is then validated with literature reports (for e.g., Gabriel, Kerron J., et al., Industrial & Engineering Chemistry Research 53.17 (2014): 7087-7102.) to validate the performance. Finally, the novel CARGEN® technology as per our previous disclosure (US20200109050A1) is introduced with changes that are necessary for its incorporation in the flowsheet. In the discussion below, details on the retrofitting process are provided that covers the full scope of the present invention.

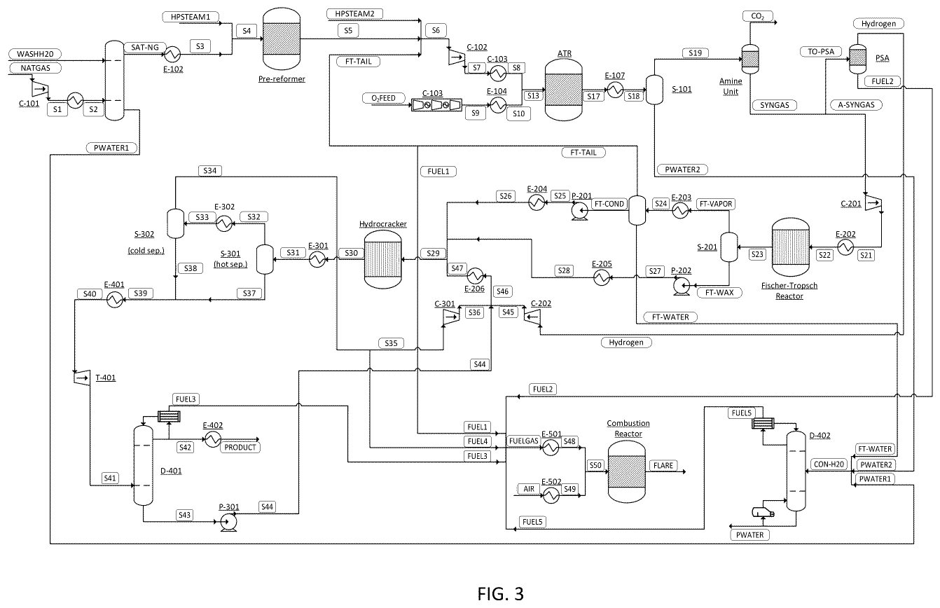

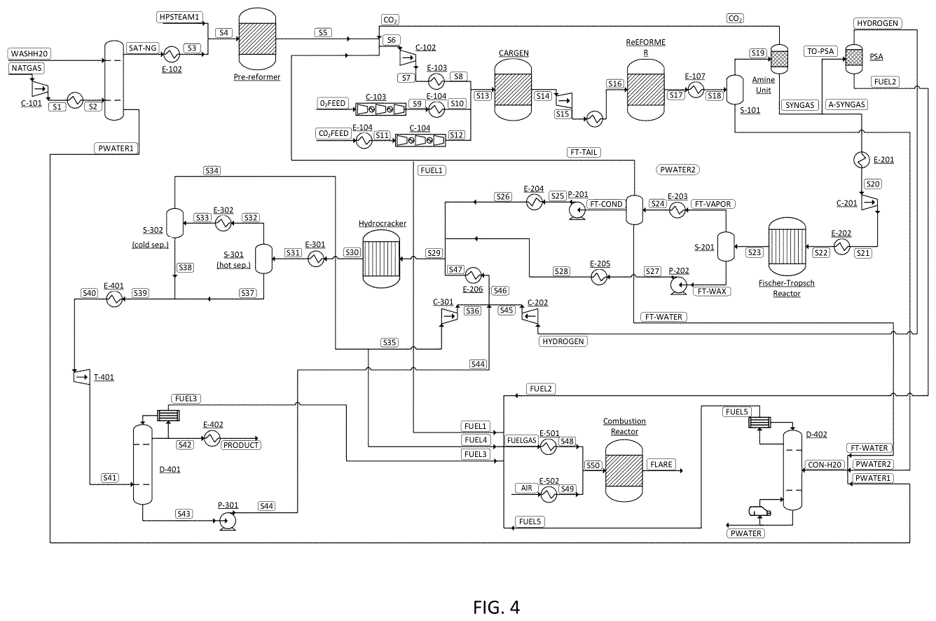

An ASPEN Plus® model is used for the production of gasoline from natural gas through a GTL superstructure including the following three main blocks: i) reforming unit for the production of syngas; ii) FT unit for the conversion of syngas to long-chain HCs; and iii) refinery for the cracking and fractionation of HCs. The CARGEN®-based GTL model is simulated using a debottlenecking approach such that the only difference between the two models is the reforming unit, whereas the other units remain the same with minimal differences. The flowsheets of the conventional reforming-based GTL plant (e.g., ATR or POX or SRM process etc.) and CARGEN®-based models are illustrated in FIGS. 3 and 4, respectively. The properties of the natural gas feedstock used in this model are provided in Table 2 below.

TABLE 2
Natural Gas Feedstock Properties

| | Mole Fraction |
|---|---|
| Component | (%) |
| CO₂ | 0.59 |
| N₂ | 0.08 |
| CH₄ | 95.39 |
| C₂H₆ | 3.91 |
| C₃H₈ | 0.03 |
| Temperature (º F.) | 79 |
| Pressure (Psia) | 310 |

The feedstock conditions of high-pressure steam (HP steam) and oxygen are also provided in Table 3 below. Oxygen is assumed to come from an air separation unit.

TABLE 3
Feedstock Properties

| | Temperature | Pressure |
|---|---|---|
| | (º F.) | (Psia) |
| HP Steam | 437 | 370 |
| Oxygen | 95 | 17 |

The retrofitted model may be developed through debottlenecking approach; wherein, the conventional reforming process (e.g., ATR or POX or SRM etc.) unit is replaced with the two-reactor CARGEN® setup and with minimal changes to the other units of the plant. A process description of the CARGEN® reforming along with the additional changes required upon replacing conventional reforming process (e.g., ATR or POX or SRM etc.) are detailed in the subsequent paragraphs.

Natural gas may be first saturated, pre-reformed, and combined with recycled tail gas. Unlike conventional reforming process (e.g., ATR or POX or SRM etc.), no additional steam may be needed in the CARGEN® process as the oxygen feed controls the syngas ratio. This may be done using a design specification that manipulates the stream flowrate such that the syngas obtained from the reformer is 2.15. The CxHy:CO₂:O₂ ratio of 1:0.6:0.1 may be met to satisfy the CARGEN® feed ratio requirement. Therefore, the oxygen stream may be first compressed to 363 psia in a multistage compressor and heated to 788° F. Meanwhile, CO₂ may be fed to the CARGEN® reactor at a ratio of CO₂:C of 1:1. Therefore, this process may require a constant and fresh source of CO₂. It can be obtained by recycling the CO₂ stream obtained from the amine unit. In conventional reforming process (e.g., ATR or POX or SRM etc.), the CO₂ obtained is purged. However, in the CARGEN® setup, this CO₂ may be recycled back and mixed with additional fresh CO₂ to meet the CO₂:C ratio of 1:1. The flowrate of the additional CO₂ may be set through a calculator block, per the following mathematical correlation:

$${CO}_{2 - h}^{′} = {C}_{1}^{′} + 2 {C}_{2}^{′} + … + 9 {C}_{9}^{′} + 10 {C}_{10}^{′} - {CO}_{2 - i}^{′} \qquad Eq . 6$$

Where, ‘CO_{2-Fresh}′’ is the flowrate of the additional CO₂ to be fed to the reactor, ‘C₁′’ to ‘C₁₀′’ are the flowrates of methane to n-decane present in the pre-reformed gases and the recycled tail gas. The flowrates of ‘C₁₁H₂₄’ and ‘C₃₀H₆₂’ are assumed to be negligible. ‘CO₂₋ᵢ′’ is the flowrate of the recycled CO₂ stream obtained from a CO₂ separation system (for e.g., from the amine CO2 separation unit). The recycled CO₂ may be combined with the recycled FT tail gas and the pre-reformed gases. It may be then compressed to 363 psia and heated to 788° F. The CO₂ feedstock may be assumed to be separated and obtained from the flare. Example properties of the flared gas may be provided in Table 4 below.

TABLE 4
Flare gas properties

| | Mole Fraction |
|---|---|
| Component | (%) |
| CO₂ | 7.86 |
| N₂ | 71.60 |
| H₂O | 15.84 |
| O₂ | 4.70 |
| Temperature (º F.) | 2000 |
| Pressure (Psia) | 362 |

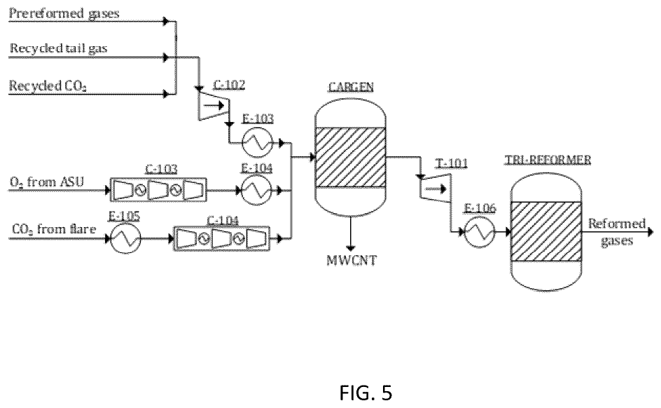

Therefore, the fresh CO₂ may be assumed to be at flare gas conditions. Therefore, this stream may be at atmospheric pressure and may be cooled before compression. First, it may be fed to a heat exchanger where its temperature is cooled to 79° F. Then, it may be compressed in a multistage compressor to 363 psia with a stage cooler temperature set to 788° F. It should be noted that there may be multiple steps of interstage cooling between the multiple stages of compression for all practical purposes pertaining to the limits of the operation of the compressors. This scheme of operation is presented in FIG. 5.

The streams may then be mixed and fed to the CARGEN® reactor. It may be modeled to operate adiabatically at 363 psia. Additionally, a constraint may be set to ensure that the product temperature does not exceed the maximum temperature range (e.g., 1148° F.) of the CARGEN® process. The reactor may be designed to produce two phases, solid and vapor, obtained from two different product streams, as seen in FIG. 5.

The vapor phase may then be expanded to 290 psia and heated to 1508° F. to meet the tri-reformer operational temperature. The reformer may be operated isothermally. The syngas ratio obtained from the tri-reformer may be maintained at 2.15 through a design specification that may vary the inlet oxygen flowrate. Finally, the reformed gases may be taken to heat recovery and water separation.

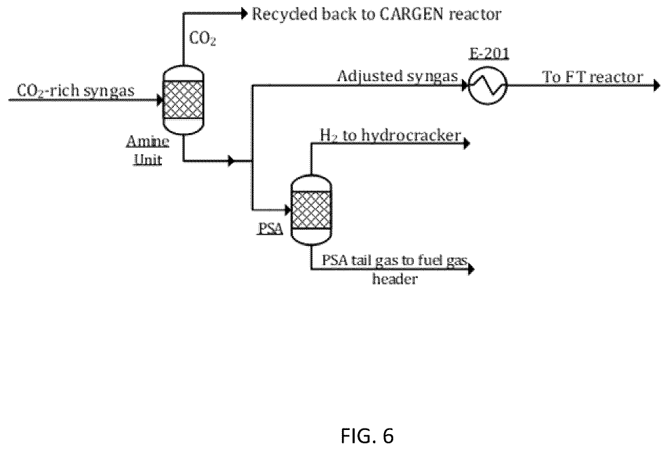

The syngas may need to be conditioned before the FT reaction. However, instead of purging the CO₂, it may be recycled back to the reactor. In addition, the syngas obtained from the CARGEN® setup may have a 50% higher steam content than that obtained from conventional reforming process (e.g., ATR or POX or SRM etc.). Therefore, to avoid dew temperature issues in the pre-FT reactor compression, the adjusted syngas may be heated. This heater may be used to increase the adjusted syngas' temperature, for example, to 130° F. (higher than the stream dew temperature). The adjusted syngas may then be taken to the FT synthesis unit, and the remainder of the process may be carried out as discussed above. The syngas conditioning unit of the CARGEN®-based process may be provided in FIG. 6.

### Example 1—Comparison of CARGEN® Technology with Benchmark Conventional Reforming Process (e.g., ATR or POX or SRM Etc.) Process

To evaluate the performance of the CARGEN® process, its benchmark indicators are compared to those of the modeled conventional reforming process (e.g., ATR or POX or SRM etc.) to determine the effect of replacing the conventional reforming process (e.g., ATR or POX or SRM etc.) with a CARGEN® unit. The targeted indicators are the natural gas requirement, the net water generation, direct and indirect CO₂ emissions, oxygen consumption, syngas conversion, and the amount of MWCNT's produced. In Table 7 below, a comparison of the Key Performance Indicators (KPI) results along with their comparative difference is provided.

TABLE 7
ATR-based and CARGEN ®-based model KPI comparison

| KPI | ATR | CARGEN ® | % change. |
|---|---|---|---|
| Nat. gas | 9,090 | 14,635 | 61% |
| Requirement | | | |
| [SCF/bbl GTL] | | | |
| Net water | 376 | 907 | 141% |
| [lb/bbl GTL] | | | |
| Direct CO₂ | 414 | −753 | −282% |
| [lb/bbl GTL] | | | |
| Oxygen | 511 | 30 | −94% |
| [lb/bbl GTL] | | | |
| Syngas | 53 | 55 | 3% |
| Conversion | | | |
| [SCF/bbl GTL] | | | |
| MWCNT | 0 | 536 | — |
| produced | | | |
| [lb/bbl GTL] | | | |
| Indirect CO2 | 70 | 126 | 79% |
| Emissions | | | |
| from Power | | | |
| Requirement | | | |
| [lb/bbl GTL] | | | |
| Indirect | 210 | | |
| Reforming | | | |
| CO2 | | | |
| Emissions | | 813 | 288% |
| from Energy | | | |
| Requirement | | | |
| [lb CO2/bbl | | | |
| GTL] | | | |
| Total CO₂ | 693 | 186 | −73% |
| emissions | | | |
| [lb/bbl GTL] | | | |

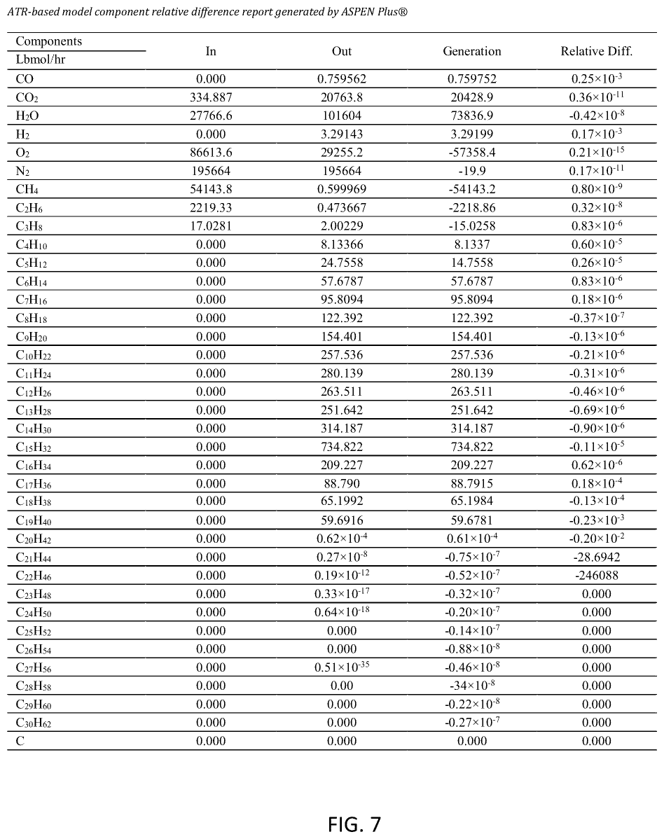

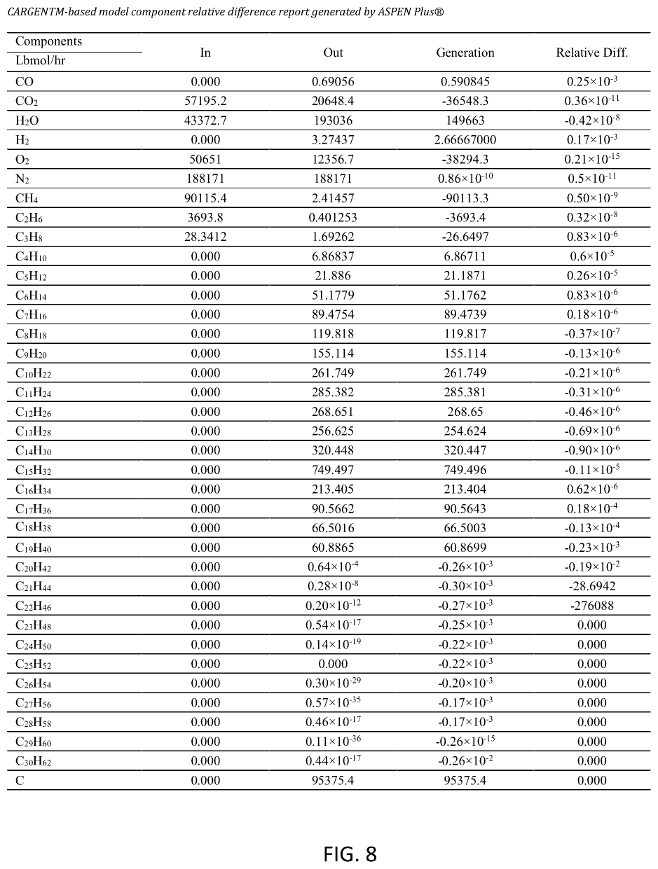

From the provided results, it can be seen that the CARGEN®-based process requires 61% more natural gas per barrel of GTL, which is also reported in FIGS. 7 and 8. This is because the CARGEN® technology produces two products (MWCNT and syngas), whereas the conventional reforming process (e.g., ATR or POX or SRM etc.) produces only syngas.

Meanwhile, it is seen that the overall generation of water in the CARGEN®-based process is 141% more than that of the conventional reforming process (e.g., ATR or POX or SRM etc.), which is also reported in FIGS. 7 and 8. This water can be recycled or used for irrigation or as utility, among several other important uses in the industry.

In terms of oxygen consumption, the CARGEN® process shows a 94% reduction in its oxygen feed requirement due to the low CxHy:O₂ ratio of 1:0.1 compared to the conventional reforming process (e.g., ATR or POX or SRM etc.) process. This highly improves the plant's economy while also reducing the Air Separation Unit (ASU) operating cost.

As for the syngas conversion, both processes have a similar conversion as expected, as changing the reforming process does not affect the FT process, and the same amount of syngas is required for producing a barrel of GTL.

Another significant difference between the two processes is the production of solid carbon. Through the CARGEN® process, 536 lb of MWCNT are produced per barrel of GTL. This offers a great advantage to the GTL process as through replacing the conventional reforming process (e.g., ATR or POX or SRM etc.); the plant becomes more sustainable while also producing a valuable product, solid carbon, which may be in the form of MWCNT.

Differences in direct CO₂ emissions: A significant effect of replacing the CARGEN® unit with conventional reforming process (e.g., ATR or POX or SRM etc.) is the significant drop in CO₂ emissions. In fact, by switching to CARGEN®, the overall GTL process goes from being a net producer of CO₂ to a net consumer in terms of its direct emissions. While the conventional reforming process (e.g., ATR or POX or SRM etc.) reactor produces large amounts of CO₂ that are flared into the atmosphere, the CO₂ produced from the CARGEN® reactor setup is recycled while also utilizing additional CO₂ from external sources to meet the C to CO₂ ratio of 1:0.6. Therefore, by switching to CARGEN® technology, the direct CO₂ emission drops from 395 to −753 lb of CO₂ per barrel of GTL, in other words, almost 280% reduction.

Differences in indirect CO₂ emissions: A 79% increase in the indirect CO₂ emissions is evaluated in the CARGEN® Technology-based GTL plant due to higher power requirements. This increase is attributed to the additional compression required for the fresh CO₂ from atmospheric pressure to meet the reactor operating condition. Another contributor to the high-power requirement is the increase in the flowrate of natural gas compared to the conventional reforming process (e.g., ATR or POX or SRM etc.), leading to an added compression requirement. However, it is seen that the CARGEN®-based GTL process requires 94% less oxygen, which means that the ASU will require a much lower power requirement.

Differences in overall CO₂ emissions: The overall CO₂ emissions of the GTL plant after accounting for both direct and indirect CO₂ emissions is reduced by 73% after implementing CARGEN® technology.

### Example 2—Economics Evaluation of the CARGEN® Technology

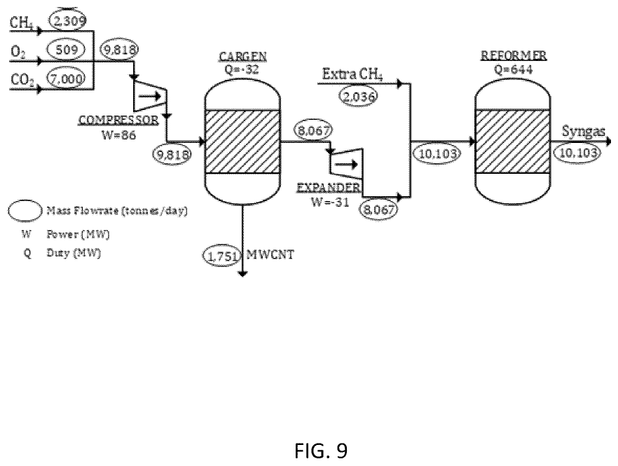

In this example we demonstrate the implementation and economics value addition of CARGEN® Technology to convert GHG emissions produced from a midstream process plant. The considered scenario includes 14 midstream processing trains, whereby each process train emits at least 500 tons per day of CO₂. Therefore, the emission from 14 trains would become 7,000 tons/day. A simulation study conducted on this capacity of CO₂ using CARGEN® in ASPEN© plus process simulator is shown in FIG. 9.

Example operational conditions of the CARGEN® and the tri-reforming reactor are provided below:
CARGEN®:
Temperature=1,022° F.
Pressure=363 psia
Reformer:
Temperature=1,472° F.
Pressure=14.5 psia
Feed composition:
CH₄=2,309+2,036 tonnes/day
CO₂=7,000 tonnes/day
O₂=509 tonnes/day
Products:
Carbon production from CARGEN®=1,751 tonnes/day
Syngas production from reformer=10,103 tonnes/day
Overall conversions:
CO₂=83%
CH₄=97%

Out of the said amount of syngas products, the actual syngas (H₂+CO) content in the mixture would be: (H₂+CO)=977+6,838 (TPD). Assuming that 50% of the syngas is converted to HC products, only 6838/2 (or 3419) TPD of CO₂ and 977/2 (or 488 TPD) of H₂ is converted to HC. Assuming that all of these are converted to gasoline products that contains C₆ to C₁₂ HCs, averaging at C₉, the overall stoichiometric equation becomes:

$$9 CO + 18 {H}_{2} \to {C}_{9} {H}_{18} + 9 {H}_{2} O \qquad Eq . 10$$

Therefore, total C₉H₁₈ produced would be:

$$\frac{( \frac{6838}{2} )}{28} \times \frac{1}{9} \times 126 = 3 , 419 TPD \qquad Eq . 11$$

Therefore, the volume of gasoline produced would be:

$$3419 \times 1000 \times \frac{1}{800} = 4 , 274 \frac{{m}^{3}}{day} \qquad Eq . 12$$

$$4 , 274 \times 6.29 = 26 , 877 \frac{bbl}{day} \qquad Eq . 13$$

$$∵ 1 bbl = 159 litres \qquad Eq . 14$$

$$∵ 4 , 274 \frac{{m}^{3}}{d a y} = 4 , 274 \times \frac{1 {0}^{3}}{159} \frac{bbl}{day} \approx 26 , 800 \frac{bbl}{day} \qquad Eq . 15$$

∵ Current market value per liter of gasoline in the Middle East≈0.3 USD/litre litre
∴ Additional revenue generation possibility:

$$\approx 4 , 274 \times 1000 \times 0.3 \frac{USD}{day} ∼ 1.2 \times {10}^{6} \frac{USD}{day} \qquad Eq . 16$$

Therefore, the GTL products can generate about 1.2 MM USD/day additional revenue upon implementation of CARGEN® technology.

As used in the examples above, “about,” “approximately,” and “substantially” are understood to refer to numbers in a range of numerals, for example, the range of −20% to +20% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used herein and in the appended claims, the singular form of a word includes the plural, unless the context clearly dictates otherwise. Thus, the references “a,” “an,” and “the” are generally inclusive of the plurals of the respective terms. For example, reference to “an ingredient” or “a method” includes a plurality of such “ingredients” or “methods.” The term “and/or” used in the context of “X and/or Y” should be interpreted as “X,” or “Y,” or “X and Y”.

Similarly, the words “comprise,” “comprises,” and “comprising” are to be interpreted inclusively rather than exclusively. Likewise, the terms “include,” “including,” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” is also a disclosure of embodiments “consisting essentially of” and “consisting of” the disclosed components. Where used herein, the term “example,” particularly when followed by a listing of terms, is merely exemplary and illustrative, and should not be deemed to be exclusive or comprehensive. Any embodiment disclosed herein can be combined with any other embodiment disclosed herein unless explicitly indicated otherwise.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A CARGEN based retrofitted gas to liquids (GTL) process system comprising:
a CARGEN technology modified natural gas reforming section;
a Fischer-Tropsch (FT) reaction section;
a refining section; and
a water treatment section,
wherein the CARGEN technology modified natural gas reforming section is configured to:
receive an input gas comprising a combination of natural gas, recycled FT tail gas, and recycled CO2; and
produce carbon material and syngas; and
wherein the recycled CO₂ is recycled from a CO₂ separation system and disposed between the CARGEN technology modified natural gas reforming section and the FT reaction section.

2. The system of claim 1, wherein the FT tail gas is recycled from the FT reaction section.

3. The system of claim 1, wherein the recycled FT tail gas comprises H2 and CO.

4. The system of claim 1, wherein the natural gas is saturated and pre-reformed before the natural gas is combined with the recycled FT tail gas and the recycled CO2.

5. The system of claim 1, wherein the input gas has a CxHy:CO2:O2 feed ratio in a range of 1:0.01:0 to 1:1.5:1.

6. The system of claim 5, wherein the CxHy:CO2:O2 feed ratio of the input gas is 1:1:0.1.

7. The system of claim 1, wherein the CARGEN technology modified natural gas reforming section comprises a first reactor and a second reactor, wherein the first reactor is configured to receive the input gas.

8. The system of claim 7, wherein the first reactor is configured to operate adiabatically at a pressure in a range of 1 bar to 25 bar and a maximum outlet temperature in a range of 752° F. to 1202° F.

9. The system of claim 7, wherein the first reactor is configured to produce a solid phase product, and a vapor phase product, wherein the solid phase product comprises the carbon material, wherein the second reactor is configured to receive the vapor phase product.

10. The system of claim 9, wherein the vapor phase product comprises unreacted gases, wherein the unreacted gases comprise CO2, CH4, CO, H2, and H2O.

11. The system of claim 9, wherein the second reactor is configured to operate isothermally at a temperature in a range of 1292° F.12 to 2192° F. and at a pressure in a range of 1 bar to 25 bar.

12. The system of claim 9, wherein the second reactor is configured to convert the vapor phase product to the syngas, wherein the converted syngas has an H2:CO ratio in a range of 0.1 to 5.

13. The system of claim 12, wherein the converted syngas is delivered to the FT reaction section after the CO2 is removed by the amine unit, wherein at least a portion of the CO2 removed from the syngas by the amine unit becomes the recycled CO2 in the input gas.

14. The system of claim 13, wherein the FT reaction section is configured to convert the syngas to hydrocarbons.

15. The system of claim 1, wherein the carbon material comprises multi-walled carbon nanotubes.

16. A process comprising integrating a gas to liquids (GTL) process with a CARGEN based process thereby reducing a CO2 footprint during processing, wherein the process comprises:
providing an input gas into a CARGEN technology modified natural gas reforming section in a CARGEN based retrofitted GTL process system, wherein the input gas comprises a combination of natural gas, recycled FT tail gas, and recycled CO2, wherein the CARGEN based retrofitted GTL process system further comprises a Fischer Tropsch (FT) reaction section, a refining section, and a water treatment section,
producing, by the CARGEN technology modified natural gas reforming section, carbon material and syngas,
wherein the recycled CO2 is recycled from an amine unit disposed between the CARGEN technology modified natural gas reforming section and the FT reaction section.

17. The process of claim 16, wherein the FT tail gas is recycled from the FT reaction section.

18. The process of claim 16, wherein the recycled FT tail gas comprises H2 and CO.

19. The process of claim 16, wherein the input gas has a CxHy:CO2:O2 feed ratio in a range of 1:0.01:0 to 1:1.5:1.

20. The process of claim 19, wherein the CxHy:CO2:O2 feed ratio of the input gas is 1:1:0.1.
